(19) United States
(12) Patent Application Publication
(10) Pub. No.: US 2002/0144411 A1
(43) Pub. Date: Oct. 10, 2002

(54) Double edged roofers saw blade

(76) Inventor: Robert Brooks, Aptos, CA (US)

Correspondence Address: Jeffrey A. Hall, 212 Clinton Street, Santa Cruz, CA, 95062, US

(21) Appl. No.: 09/829,523

(22) Filed: Apr. 9, 2001

(51) Int. Cl. B23D 49/04

(52) U.S. Cl. 30/392; 83/835

(57) ABSTRACT

A double sided saw blade for operable engagement with a powered drive unit such as a reciprocating saw, comprises a thin elongated metal blade having opposed longitudinal side edges provided with first and second parallel saw tooth cutting edges. A handle element is secured to the blade and includes a mechanism for securing the handle to the powered drive unit.

### BACKGROUND OF THE INVENTION

### 37 C.F.R. 1.77(a)(7)

1. Field of Invention

This invention relates to saw blades, and more particularly to a double sided reversible blade which is secured to a handle element for connection to a reciprocating saw or other powered drive unit.

2. Description of the Related Art

Heretofore a wide variety of saw blades and associated devices have been proposed and developed. Usually such blades are formed of a bimetallic construction and utilize a steel strip with a cutting edge. These blades are resistant to breakage, but the cutting edges are subject to wear. When the cutting blades become dull, the blade must be discarded.

The present invention provides a novel double sided revisable blade having a handle element secured thereto for operable engagement to a powered drive unit such as a reciprocating saw. The device of the present invention is extremely useful for use in roofing operations, for example, for cutting hidden nails in shakes, wood shingles, cement tiles, senthedic shakes, slate and the like.

Although various type of saw blades are known in the prior art, none are directed to a double bladed saw blade attached to a handle element which has means for operable engagement to a powered drive unit, such as a reciprocating saw.

The present invention provides a novel and unique device which is highly efficient at both cutting and removing shingles, shakes, tiles and the like from roofs and other surfaces. Because of its high efficiency great savings in time and labor to complete a roofing operation are acheived.

Accordingly, it is the primary object of this invention to provide a double sided reversible saw blade having a handle with means for attachment to a powered drive unit. The device of the present invention is also inexpensive to manufacture and use, and may be used in a wide variety of applications resulting in significant reductions in both time and labor to complete a job.

Additional objects and advantages of the invention will be set forth in the description which follows, and in part will be obvious from the description, or may be learned by practice of the invention. The objects and advantages of the invention may be realized and obtained by means of the instrumentality's and combinations particularly pointed out in the appended claims

### BRIEF SUMMARY OF THE INVENTION

### 37 C.F.R. 1.77(a)(8)

The present invention is a device for rapidly and efficiently cutting and removing nails in shakes, shingles, tiles and the like comprising a double sided saw blade for operable engagement with a powered drive unit such as a reciprocating saw. The saw blade is a thin elongated metal blade having opposed longitudinal side edges provided with first and second parallel saw tooth cutting edges. A handle element is secured to the blade and includes a mechanism for securing the handle to the powered drive unit. The powered drive unit may be a reciprocating saw or other power tool.

### BRIEF DESCRIPTION OF THE DRAWINGS

The accompanying drawings, which are incorporated in and constitute a part of the specification, illustrate a preferred embodiment of the invention and, together with a general description given above and the detailed description of the preferred embodiment given below, serve to explain the principles of the invention.

FIG. 1 is a top view of the device of the present invention showing a double edged saw blade secured to a handle, and a powered drive unit, such as a reciprocating saw, according to the invention.

FIG. 2 shows an exploded view of such device, according to the invention.

### DETAILED DESCRIPTION OF THE INVENTION

### 37 C.F.R. 1.77(a)(10)

Reference will now be made in detail to the present preferred embodiments of the invention as illustrated in the accompanying drawings.

In accordance with the present invention, there is provided a double sided saw blade for operable engagement with a powered drive unit such as a reciprocating saw, comprising a thin elongated metal blade having opposed longitudinal side edges provided with first and second parallel saw tooth cutting edges. A handle element is secured to the blade and includes a mechanism for securing the handle to the powered drive unit.

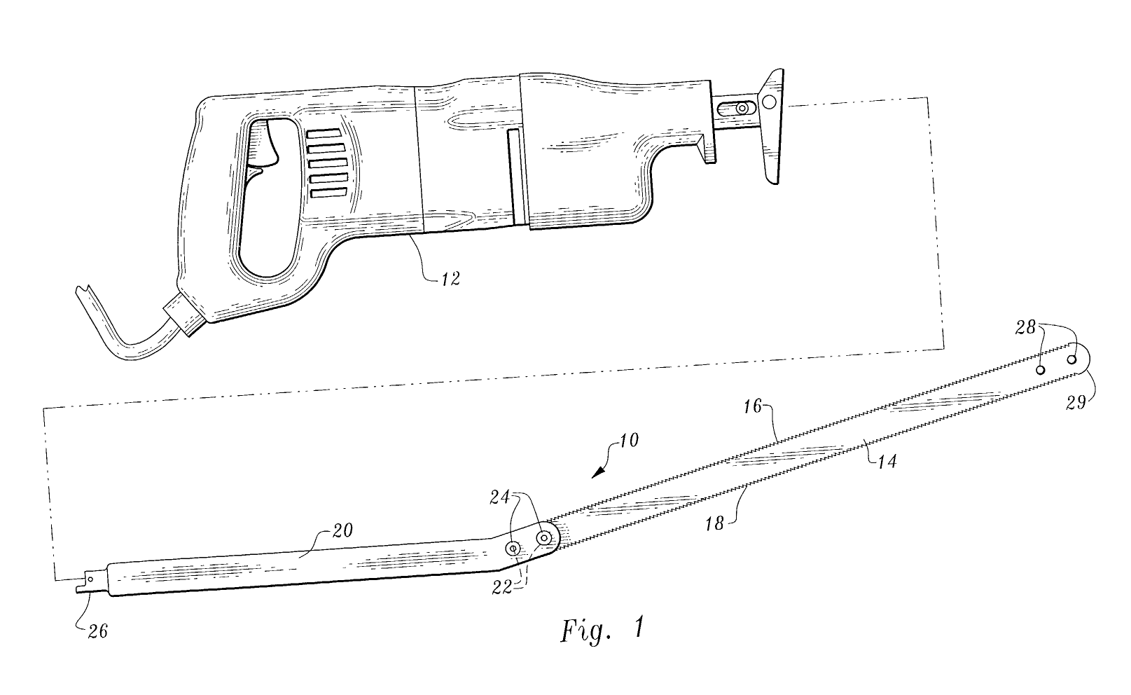

In FIG. 1, double edged roofers saw blade device 10, is shown according to a preferred embodiment of the invention. Preferably, saw blade 14 for operable engagement with a powered drive unit 12, comprises a thin elongated metal strip or blade 14 having opposed longitudinal side edges provided with first 16 and second 18 parallel saw tooth cutting edges. Blade 14, may be provided with first and second cutting edges 16 and 18, with the same or having different pitches

A handle element 20, preferably includes means for securing the handle element 20 to saw blade 14. Preferably, the means for securing handle element 20 to blade 14 comprises a pair of apertures 22, sized to secure a pair of bolts 24, and locking nuts thereto.

Means for operably securing handle 20 to powered drive unit 12,. preferably comprises an extension element 26 with an aperture therein for operable attachment to powered drive unit 12. Powered drive unit 12, may be a variety of powered units, but is preferably a reciprocating saw to which handle 20 is sized and configured to attach to.

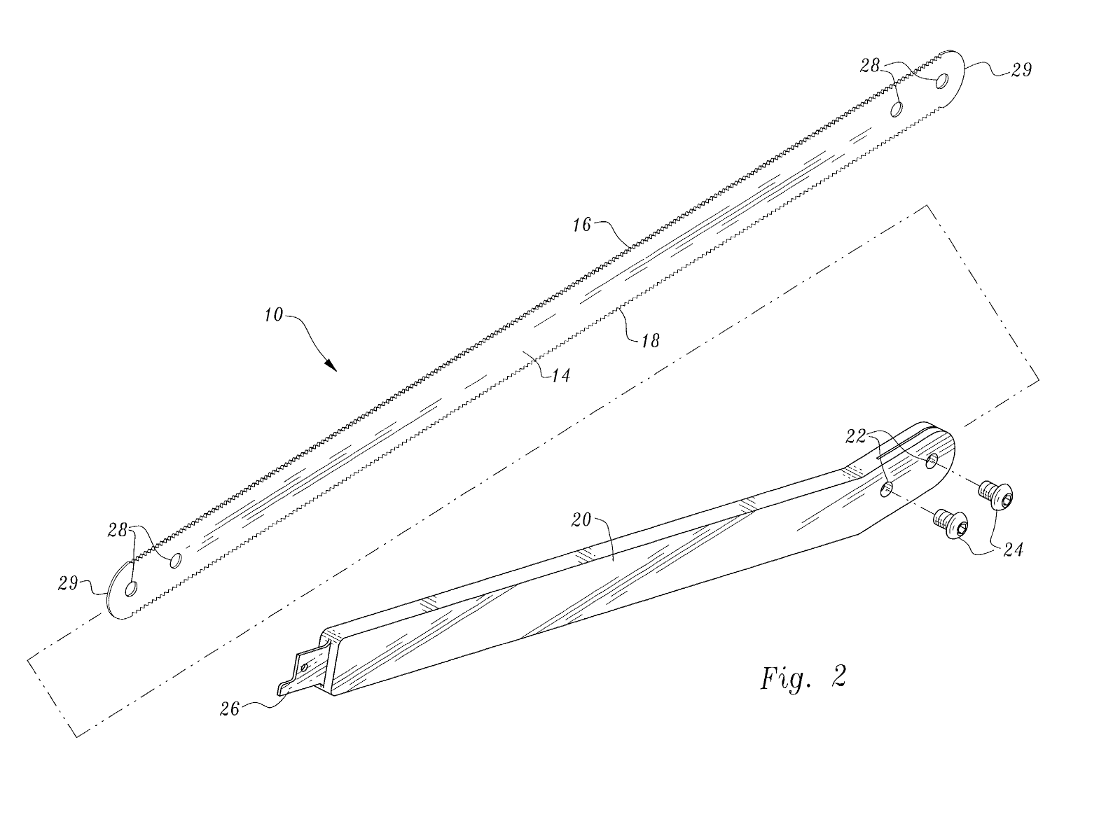

Double edged saw 10, may also include means for reversibly securing blade 14 to handle 20 to allow alternative use of the first and second cutting edges 16 and 18. This may be accomplished by apertures 28 located near the tip of blade 14. As seen in FIGS. 1 and 2, tip 28 is preferably rounded

With reference to FIG. 2, doubled edges saw blade device 10 is shown detached from powered drive unit 12. As seen in FIGS. 1 an 2, handle 20 is preferably secured to blade 14 at a slight angle, but may be otherwise.

In operation and use double edged roofers saw blade 10 is highly efficient for removing shakes and shingles of all types. It is very efficient and effective at cutting nails in shakes and shingles, and may be used efficiently and economically on all types of shakes, shingles, and slate roofing.

As is evident from the above description, a wide variety of devices may be configured for may different applications which utilize the double edged blade and device described herein and additional advantages and modifications will readily occur to those skilled in the art. The invention in its broader aspects is, therefore, not limited to the specific details, representative apparatus and illustrative examples shown and described. Accordingly, departures from such details may be made without departing from the spirit or scope of the applicant's general inventive concept

What is claimed is:

1. A saw blade for operable engagement with a powered drive unit, comprising:
a thin elongated metal strip having opposed longitudinal side edges provided with first and second parallel saw tooth cutting edges;
a handle element, said handle element including means for securing said handle element to said thin elongated metal strip;
means for operably securing said handle element to a powered drive unit.

2. The saw blade of claim 1, wherein said means for securing said handle element to said thin elongated metal strip comprises a pair of apertures sized to secure a pair of bolts and locking nuts thereto.

3. The saw blade of claim 1, wherein said powered drive unit is a reciprocating saw.

4. The saw blade of claim 1, wherein said means for operably securing said handle element to said powered drive unit comprises an extension element with an aperture therein for operable attachment to said powered drive unit.

5. The saw blade of claim 1, further including means for reversibly securing said thin elongated metal strip to said handle element to allow alternative use of said first and second cutting edges.

6. The saw blade of claim 1, wherein said first and said second cutting edges have a different pitch.

7. A device for operable engagement with a powered reciprocating saw, comprising:
a thin elongated metal blade having opposed longitudinal side edges provided with first and second parallel saw tooth cutting edges;
a handle element, said handle element including means for securing said handle element to said thin elongated metal blade;
means for operably securing said handle element to said powered reciprocating saw.

8. The device of claim 7, wherein said means for securing said handle element to said thin elongated metal blade comprises a pair of apertures sized to secure a pair of bolts and locking nuts thereto.

9. The device of claim 7, wherein said powered reciprocating saw is a hand held powered reciprocating saw.

10. The device of claim 7, wherein said means for operably securing said handle element to said powered reciprocating saw comprises an extension element with an aperture therein for operable attachment to said powered reciprocating saw.

11. The device of claim 7, further including means for reversibly securing said thin elongated metal blade to said handle element to allow alternative use of said first and second cutting edges.

12. The device of claim 7, wherein said first and said second cutting edges have a different pitch.
